(19) United States
(12) Patent Application Publication
(10) Pub. No.: US 2015/0066628 A1
(43) Pub. Date: Mar. 5, 2015

(54) CREATING AND EVALUATING CHANGES TO ADVERTISING CAMPAIGNS OF AN ADVERTISER

(71) Applicants: Arijit Ghosh, Redmond, WA (US); Umesh Unnikrishnan, Seattle, WA (US)

(72) Inventors: Arijit Ghosh, Redmond, WA (US); Umesh Unnikrishnan, Seattle, WA (US)

(73) Assignee: Google Inc.

(21) Appl. No.: 13/359,073

(22) Filed: Jan. 26, 2012

(51) Int. Cl. G06Q 30/02

(52) U.S. Cl. 705/14.43

(57) ABSTRACT

Methods, systems, and non-transitory computer-readable media for evaluating changes to one or more advertising campaigns of an advertiser. In one aspect, advertising campaign modification data, specifying advertising campaign changes, is received from a campaign modification data source. A queue of changes based on the advertising campaign modification data is generated, and the changes from the queue are evaluated. It is determined whether to apply the changes to the advertising campaign based on results of the evaluating step and rule data specifying advertising campaign performance metrics and predefined performance metric values.

### BACKGROUND

To reach more customers, companies increasingly advertise their products and services online using online advertisement systems. The advertisement systems enable advertisers to create and manage custom online advertising campaigns. Advertisers need to regularly make changes to their advertising campaign settings in order to continuously attract new customers to their websites and remain competitive with other advertisers offering similar products and services. However, optimizing advertising campaigns to meet advertiser goals and determining the impact of various advertising campaign changes on performance of advertisements is difficult and challenging.

### SUMMARY

One approach to evaluating changes to one or more advertising campaigns of an advertiser is a method. The method includes storing data associated with the one or more advertising campaigns in a memory. The method further includes receiving, over a network, advertising campaign modification data from one or more campaign modification data sources. The advertising campaign modification data specifies one or more changes to at least one of the one or more advertising campaigns. The method further includes receiving rule data associated with the one or more advertising campaigns. The rule data includes data for a first rule. The first rule evaluates an advertising campaign performance metric against a predefined performance metric value. The method further includes generating, using one or more processors, a queue of changes based on the received advertising campaign modification data. The method further includes evaluating, using the one or more processors, one or more changes from the queue associated with a first campaign in the one or more advertising campaigns for a predetermined period of time. The method further includes determining, using the one or more processors, whether to apply the one or more changes to the first advertising campaign based on results of the evaluating step and the first rule.

Another approach to evaluating changes to one or more advertising campaigns of an advertiser is a computerized system. The system includes one or more processing circuits. The one or more processing circuits are configured to receive, over a network, advertising campaign modification data from one or more campaign modification data sources. The advertising campaign modification data specifies one or more changes to at least one of the one or more advertising campaigns. The one or more processing circuits are further configured to receive rule data associated with the one or more advertising campaigns. The rule data includes data for a first rule. The first rule evaluates an advertising campaign performance metric against a predefined performance metric value. The one or more processing circuits are further configured to generate a queue of changes based on the received advertising campaign modification data. The one or more processing circuits are further configured to evaluate one or more changes from the queue associated with a first campaign in the one or more advertising campaigns for a predetermined period of time. The one or more processing circuits are further configured to determine whether to apply the one or more changes to the first advertising campaign based on results of the evaluating step and the first rule.

Another approach to evaluating changes to one or more advertising campaigns of an advertiser is a non-transitory computer-readable medium having instructions stored thereon. The instructions comprise instructions to receive, over a network, advertising campaign modification data from one or more campaign modification data sources. The advertising campaign modification data specifies one or more changes to at least of the one or more advertising campaigns. The instructions further comprise instructions to receive rule data associated with the one or more advertising campaigns, wherein the rule data includes data for a first rule. The first rule evaluates an advertising campaign performance metric against a predefined performance metric value. The instructions further comprise instructions to generate a queue of changes based on the received advertising campaign modification data. The instructions further comprise instructions to evaluate one or more changes from the queue associated with a first campaign in the one or more advertising campaigns for a predetermined period of time. The instructions further comprise instructions to determine whether to apply the one or more changes to the first advertising campaign based on results of the evaluating step and the first rule.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 illustrates a block diagram of an example environment in which an advertisement system manages advertising services in accordance with an illustrative embodiment;

FIG. 2 is a flow diagram of an example process for evaluating changes to an advertising campaign in accordance with an illustrative embodiment;

FIG. 3 is a flow diagram of an example process for experimenting with changes for multiple advertising campaigns in accordance with an illustrative embodiment;

FIG. 4 illustrates a user interface for displaying results of an advertising campaign experiment in accordance with an illustrative embodiment;

FIG. 5 illustrates a user interface for displaying results of an advertising campaign experiment in accordance with an illustrative embodiment;

FIG. 6 illustrates a user interface for creating an experiment in accordance with an illustrative embodiment; and

FIG. 7 is a block diagram of a computer system in accordance with an illustrative embodiment.

Like reference numbers and designations in the various drawings indicate like elements.

### DETAILED DESCRIPTION

In an advertisement management system, advertisers can create one or more advertising campaigns to advertise various products and services online. For example, the advertiser can organize the advertising campaigns by specific product or product class. At the advertising campaign level, the advertiser can select a daily budget, geographic targeting, language targeting, distribution preferences, end dates, etc. Any single advertising campaign may be as simple as a single keyword bid, or as complicated as multiple advertising groups with multiple keywords.

Each advertising campaign can include one or more advertising groups. An advertising group can focus on a single product, a brand, etc. In turn, for each advertising group, the advertiser can create custom advertisements, and select one or more keywords, targeting services and/or products that the advertisements promote. Cost per click (CPC) bids, indicating price the advertiser is willing to pay for clicks or impressions on the advertisements, can be set at the advertising group level or for each individual keyword.

An advertiser can manually modify various settings associated with an advertising campaign including making changes to bids, keywords, landing pages, etc. To assist the advertiser with campaign optimization, an advertisement management system 110 can generate suggested changes that would improve performance of the advertiser's campaigns (e.g., increase number of impressions and clicks on the advertisements). For example, a list of new keywords may be presented to the advertiser. In another example, changes to bids or budgets may be suggested. The advertiser can manually select one or more changes from the various changes suggested by the advertisement management system 110, and apply them to an advertising campaign.

Using the advertisement management system 110, the advertiser can experiment with the suggested changes for an advertising campaign, for a predetermined period of time (e.g., a month). In particular, using one or more user interfaces in the advertisement management system 110, the advertiser can create an experiment that holds back a portion of user traffic to test an unmodified version of the advertising campaign against a modified version of the advertising campaign. Upon completion of the experiment, the advertiser is presented with a visualization of results of the experiment illustrating the impact the advertising campaign changes had on the performance of the advertising campaign.

To allow for continuous optimization of the advertising campaigns, the advertisement management system 110 can automatically experiment with various changes to the advertiser's advertising campaigns. Various changes, generated by the advertisement management system 110 or created manually by the advertiser, can be collected in a queue, and grouped into one or more experiments. In one embodiment, only a single experiment can run at any given time on a single advertising campaign. In this embodiment, the single running experiment can include changes to one advertising campaign. In another embodiment, two or more experiments may run at the same time, with each experiment being associated with one or more advertising campaigns.

Upon completion of the experiment (e.g., expiration of a predetermined period of time), the advertisement management system 110 determines whether to promote the evaluated changes to all user traffic. If the results of the experiment satisfy one or more rules, as identified by the advertiser or determined by the advertisement management system 110, the advertising campaign is updated with the experimented changes.

In one embodiment, only statistically significant experimental results are promoted or discarded. If results are inconclusive, the experiment can be retried with other pending changes in the queue. One or more user interfaces are provided to the advertiser to view results of previously run experiments, as well as results of a currently run experiment.

Automatic running and promotion of experiments advantageously lowers the risk of making changes to advertising campaigns, and provides for more accurate evaluation of changes.

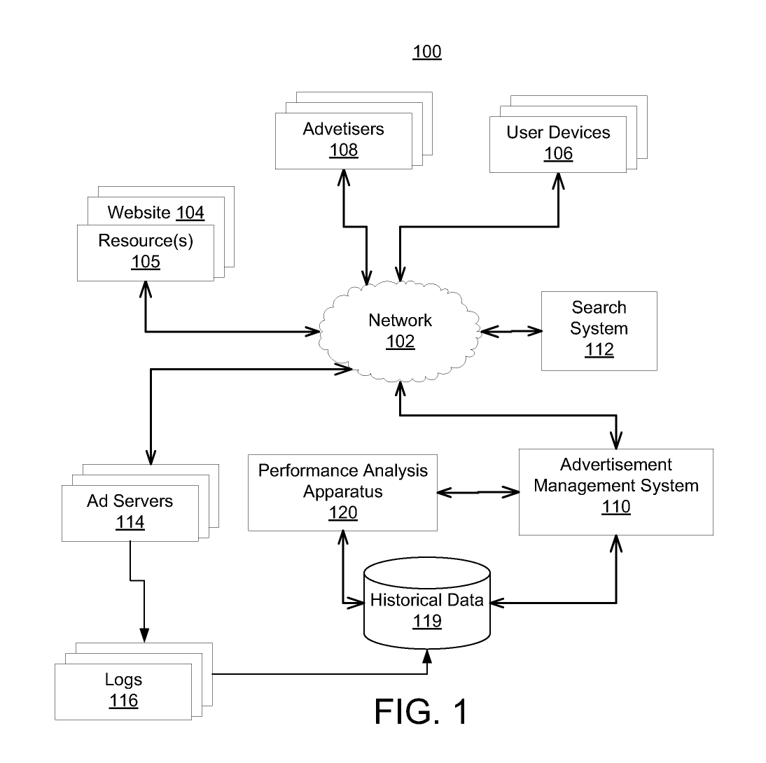

FIG. 1 is a block diagram of an example environment 100 in which the advertisement management system 110 manages advertising services. Environment 100 includes a network 102, such as a local area network (LAN), a wide area network (WAN), a wireless network, the Internet, or a combination thereof. The network 102 connects websites 104, user devices 106, advertisers 108, and the advertisement management system 110. Environment 100 may include any number of websites 104, user devices 106, and advertisers 108.

A website 104 includes one or more resources 105 associated with a domain name and hosted by one or more servers. An example website is a collection of web pages formatted in hypertext markup language (HTML) that can contain text, images, multimedia content, and programming elements, such as scripts.

The resource 105 is any data that can be provided over the network 102. The resource 105 is identified by a resource address that is associated with the resource 105, such as a URL. Resources 105 can include web pages, word processing documents, portable document format (PDF) documents, images, video, programming elements, interactive content, and feed sources, to name only a few. Resources 105 can include content, such as words, phrases, images and sounds, that may include embedded information (such as meta-information in hyperlinks) and/or embedded instructions. Embedded instructions can include code that is executed at a user's device, such as in a web browser. Code can be written in languages, such as, JavaScript® or ECMAScript®.

A user device 106 is an electronic device that is under the control of a user. User device 106 is configured to request and receive resources 105 over the network 102. Example user devices 106 include personal computers, mobile communication devices, and other devices that can send and receive data over the network 102. In some implementations, the user devices 106 may include a user application, such as a web browser, to facilitate the sending and receiving of data over the network 102.

The user devices 106 can request resources 105 from a website 104. In turn, data representing the resource 105 can be provided to user device 106 for presentation by user device 106 (e.g., on an electronic display, as an audible sound via a speaker, or a combination thereof). The data representing the resource 105 can include data specifying a portion of the resource or a portion of a user display (e.g., a presentation location of a pop-up window or in a slot of a web page) in which advertisements can be presented. These specified portions of the resource 105 or user display are referred to as advertisement slots.

To facilitate searching of the vast number of resources 105 accessible over the network 102, the environment 100 may include a search system 112 that identifies resources 105 by crawling and indexing resources 105 provided on websites 104. Data about resources 105 can be indexed based on the resource 105 with which the data is associated. The indexed and, optionally, cached copies of resources 105 are stored in a search index (not shown).

User devices 106 can submit search queries to the search system 112 over the network 102. In response, the search system 112 accesses the search index to identify resources 105 that are relevant to the search query. In one illustrative embodiment, a search query includes one or more keywords. The search system 112 identifies resources 105 that are responsive to the query, provides information about resources 105 in the form of search results and returns the search results to the user devices 106 in search results pages. A search result can include data generated by the search system 112 that identifies the resource 105 that is responsive to a particular search query, and can include a link to the resource 105. An example search result can include a web page title, a snippet of text or a portion of an image extracted from a web page, a rendering of the resource 105, and the URL of the web page. Search results pages can also include one or more advertisement slots in which advertisements can be presented.

A search result page can be sent with a request from the search system 112 for the web browser of the user device 106 to set an HTTP (HyperText Transfer Protocol) cookie. A cookie can represent, for example, a particular user device 106 and a particular web browser. For example, the search system 112 includes a server that replies to the query by sending the search results page in an HTTP response. This HTTP response includes instructions (e.g., a set cookie instruction) that cause the browser to store a cookie for the site hosted by the server or for the domain of the server. If the browser supports cookies and cookies are enabled, every subsequent page request to the same server or a server within the domain of the server will include the cookie. The cookie can store a variety of data, including a unique or semi-unique identifier. The unique or semi-unique identifier can be anonymized and is not connected with user names. Because HTTP is a stateless protocol, the use of cookies allows an external service, such as the search system 112 or other system, to track particular actions and status of a user over multiple sessions. A user may opt out of tracking user actions, for example, by disabling cookies in the browser's settings.

When the resource 105 or search results are requested by a user device 106 or provided to user device 106, the advertisement management system 110 receives a request for advertisements to be provided with the resource 105 or search results. The request for advertisements can include characteristics of the advertisement slots that are defined for the requested the resource 105 or search results page, and can be provided to advertisement management system 110. For example, a reference (e.g., URL) to the resource 105 for which the advertisement slot is defined, a size of the advertisement slot, and/or media types that are available for presentation in the advertisement slot can be provided to advertisement management system 110. Similarly, keywords (i.e., one or more words that are associated with content) associated with a requested the resource 105 (“resource keywords”) or a search query for which search results are requested can also be provided to the advertisement management system 110 to facilitate identification of advertisements that are relevant to the resource 105 or search query.

Based on the data included in the request for advertisements, the advertisement management system 110 can select advertisements that are eligible to be provided in response to the request (“eligible advertisements”). For example, eligible advertisements can include advertisements having characteristics matching the characteristics of advertisement slots and that are identified as relevant to specified resource keywords or search queries. In some implementations, advertisements having targeting keywords that match the resource keywords, the search query, or portions of the search query are selected as eligible advertisements by advertisement management system 110.

The advertisement management system 110 selects an eligible advertisement for each advertisement slot of the resource 105 or of a search results page. The resource 105 or search results page is received by the user device 106 for presentation by the user device 106. User interaction data representing user interactions with presented advertisements can be stored in a historical data store 119. For example, when an advertisement is presented to the user via an ad server 114, data can be stored in a log file 116. The log file 116 can be aggregated with other data in a historical data store 119. Accordingly, the historical data store 119 contains data representing the advertisement impression. For example, the presentation of an advertisement is stored in response to a request for the advertisement that is presented. For example, the ad request can include data identifying a particular cookie, such that data identifying the cookie can be stored in association with data that identifies the advertisement(s) that were presented in response to the request. In some implementations, the data can be stored directly to the historical data store 119.

Similarly, when a user selects to traverse a link (e.g., a hyperlink, a presented advertisement, etc.), data representing the selection of the link can be stored in the log file 116, a cookie, or the historical data store 119. In some implementations, the data is stored in response to a request for a web page that is linked to an advertisement. For example, the user selection of the advertisement can initiate a request for presentation of a web page that is provided by (or for) the advertiser. The request can include data identifying the particular cookie for the user device, and this data can be stored in the advertisement data store.

User interaction data can be associated with unique identifiers that represent a corresponding user device with which the user interactions were performed. For example, in some implementations, user interaction data can be associated with one or more cookies. Each cookie can include content which specifies an initialization time that indicates a time at which the cookie was initially set on the particular user device 106. In further implementations, additional information may be collected about a particular user. For example, additional information may include information relating to the user's demographics, geographic location (e.g., based on a GPS function in a mobile device, based on an IP address, etc.), system information (e.g., which web browser is being use, the type of computing device used, etc.), and any other type of information about a user's interaction with environment 100.

Log files 116, or historical data store 119, also store references to advertisements and data representing conditions under which each advertisement was selected for presentation to a user. For example, the historical data store 119 can store targeting keywords, bids, and other criteria with which eligible advertisements are selected for presentation. Additionally, the historical data store 119 can include data that specifies a number of impressions for each advertisement and the number of impressions for each advertisement can be tracked, for example, using the keywords that caused the advertisement impressions and/or the cookies that are associated with the impressions. Data for each impression can also be stored so that each impression and user selection can be associated with (i.e., stored with references to and/or indexed according to) the advertisement that was selected and/or the targeting keyword that caused the advertisement to be selected for presentation.

Advertisers 108 can submit, to the advertisement management system 110, campaign parameters (e.g., targeting keywords and corresponding bids) that are used to control distribution of advertisements. Advertisers 108 can access the advertisement management system 110 to monitor performance of the advertisements that are distributed using the campaign parameters. For example, an advertiser can access a campaign performance report that provides a number of impressions (i.e., presentations), selections (i.e., clicks), and conversions that have been identified for the advertisements. The campaign performance report can also provide a total cost, a cost-per-click, and other cost measures for the advertisement over a specified period of time. In some embodiments, the campaign performance report or another report generated by the advertisement management system 110 displays to the advertiser results of experiments including ongoing and past experiments.

In some implementations, when a user accesses a web page, or another resource, from a referring web page (or other resource), the referring web page (or other resource) for that interaction can be identified, for example, by execution of code that is referenced by the web page being accessed and/or based on a URL that is used to access the web page. For example, a user can access an advertiser's website by selecting a link presented on a web page, for example, as part of a promotional offer by an affiliate of the advertiser. This link can be associated with a URL that includes data (i.e., text) that uniquely identifies the resource from which the user is navigating. For example, the link http://www.example.com/homepage/% affiliate_identifier % promotion_{—}1 specifies that the user navigated to the example.com web page from a web page of the affiliate that is associated with the affiliate identifier number that is specified in the URL, and that the user was directed to the example.com web page based on a selection of the link that is included in the promotional offer that is associated with promotion_{—}1. The user interaction data for this interaction (i.e., the selection of the link) can be stored in a database and used, as described below, to facilitate performance reporting and visualizing the flow of traffic in environment 100.

The advertisement management system 110 includes a performance analysis apparatus 120 that may use traffic and other data stored in logs 116, historical data 119, or elsewhere, to generate one or more flow visualizations of traffic in environment 100. For example, performance analysis apparatus 120 may analyze cookie data to determine how many users traverse from one of websites 104 to another. In some implementations, performance analysis apparatus 120 may aggregate sets of data into nodes and/or traffic paths for the visualization. Performance analysis apparatus 120 may also determine which nodes and traffic paths are displayed in a traffic flow visualization. For example, performance analysis apparatus 120 may utilize one or more scoring functions based on the amount of traffic between nodes to determine which traffic paths are displayed. The scoring function may also be based on level weights. For example, each of the traffic paths going from nodes A to B to C may have a level weight of 1, whereas a path that traverses directly from A to C may have a level weight of 2.

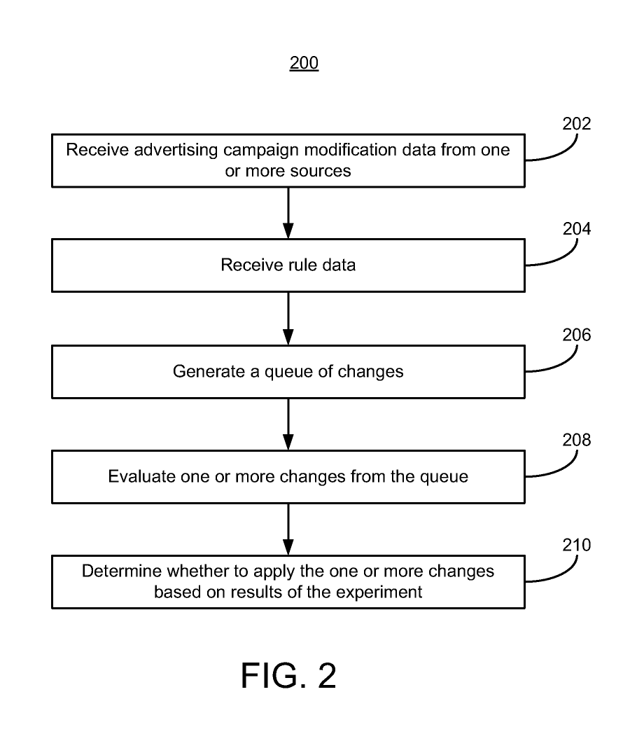

FIG. 2 is a flow diagram of a process 200 for evaluating campaign changes in accordance with an illustrative embodiment. The process 200 can be implemented on a computing device. In one embodiment, the process 200 is encoded on a computer-readable medium that contains instructions that, when executed by a computing device, cause the computing device to perform operations of the process 200.

The process 200 includes receiving modification data for one or more advertising campaigns from one or a plurality of sources 202. For example, the received modification data can include new keywords for one or more ad groups, bid changes, landing pages, geographic limiters, etc. The changes specified in the modification data can be automatically generated (e.g., without requiring a user request or user input) by the advertisement management system 110 or another system. The received modification data can include changes that the advertiser might have recently made to one or more advertising campaigns, and/or bulk changes imported from the advertisement management system 110 or one or more other systems.

At block 204, rule data associated with the one or more advertising campaigns is received. The received rule data can include data for one or more rules. In some embodiments, a rule evaluates an advertising campaign performance metric against a predefined performance metric value. A rule can be generated by the advertisement management system 110 based on a goal preference specified by the advertiser. The advertiser goal preferences may include an increase in click-through rates, clicks, impressions, conversions, amount of time a user spends on a landing page, and/or reduction in cost.

When the advertiser selects the increasing clicks goal preference, a rule may be generated to determine whether the number of received clicks was higher than a certain threshold level, which is predetermined by the advertiser or the advertisement management system 110. In this example, the advertising campaign performance metric is the number of received clicks metric, and the pre-defined performance metric value is the threshold level. A rule may have more than one advertising campaign performance metric and corresponding predefined performance metric values. For example, a rule may specify that a cost is to be increased by a predefined percentage and the number of clicks divided by the number of impressions is to be increased by another predefined specific percentage.

In another example, the advertiser identifies lowering cost as a goal preference, and the advertisement management system 110 generates a rule that specifies a decrease in cost by an explicit threshold, which can be set by the advertiser or the advertisement management system 110. If the cost goal is not met, the changes in the experiment may need to be rejected. When the advertiser identifies minimizing cost per click (CPC) as the goal preference, a rule can be generated that determines whether CPC was lowered by at least a certain percentage (e.g., 0.5%).

For an increase in traffic goal preference, a rule can be generated specifying that the increase in clicks/impressions needs to be higher than a specific threshold (e.g., between 1% and 95%). For example, if a change that is evaluated during the experiment involves a new keyword addition to an advertising group, and the advertising group with the new keyword received new clicks, but another advertising group, that was not in the experiment, lost clicks, and there was no overall increase in traffic, the experimented changes may be rejected.

If an advertising group with new keywords added lost clicks overall, then the keywords may need to be removed from the advertising group in the new experiment. In another example, a rule may state that when the evaluated change includes a bid increase, and the experimented advertising group lost traffic, then the changes made to the advertising group need to be removed, and if another advertising group lost traffic, the experiment should be stopped.

In case the advertiser does not specify a goal preference, a default rule is used as determined by the advertisement management system 110. In some embodiments, the rules are manually defined by advertisers based on their goals and objectives for the advertising campaigns. The advertiser may specify multiple goal preferences, in which case one or more rules are generated.

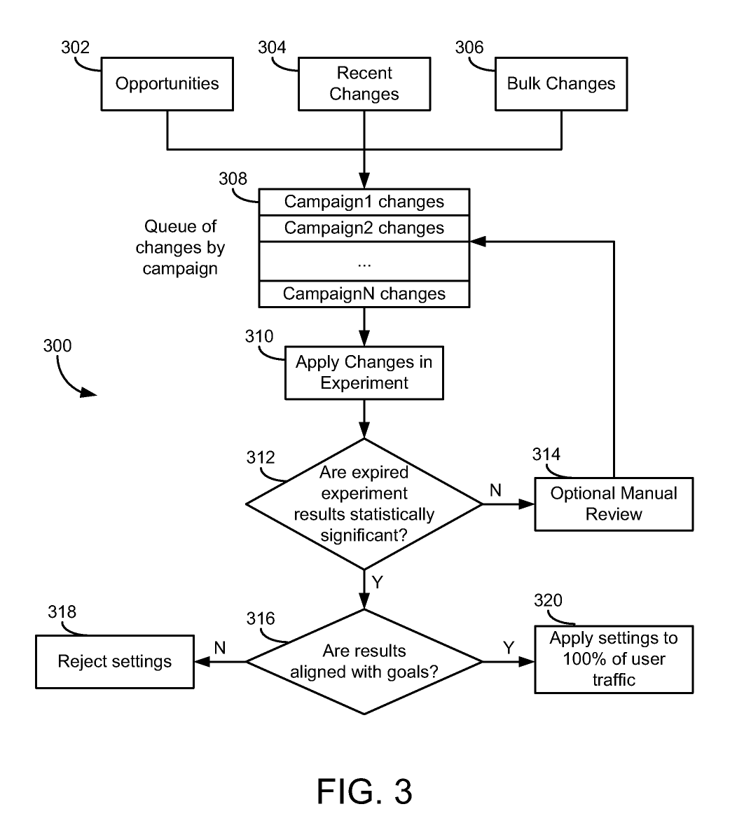

A queue of changes is generated (block 206) using the received modification data. The queue of changes can include data for one more advertising campaigns. The changes accumulated in the queue can be grouped in a variety of different ways with each group being evaluating as a separate experiment. In one embodiment, the changes are grouped by individual campaigns as illustrated in block 308 of FIG. 3. In another embodiment, changes are grouped by individual advertising groups. One or more user interfaces (not shown) can enable the advertiser to manage the queue of changes (e.g., prioritize the queue, group changes, remove changes from the queue, etc.).

One or more changes (e.g., the first group of changes) in the queue are evaluated (block 208) as further illustrated in blocks 312 and 316 of FIG. 3. In one embodiment, changes are evaluated for a single advertising campaign at a time. In this embodiment, the changes associated with the particular advertising campaign are experimented with by using a portion of user traffic to test the advertising campaign as modified by the changes against the advertising campaign without the changes. For example, a percentage of held back user traffic (e.g., 50%) can be applied to the modified version of the advertising campaign, and another percentage of user traffic (e.g., 50%) is applied to the original version of the advertising campaign. Running two versions of the advertising campaign side by side enables the advertisement management system 110 to more accurately determine the impact that the changes have on the campaign. The changes may be experimented with for a predetermined period of time (e.g., one month).

Upon lapse of the predetermined period of time, it is determined (block 210) whether to apply the experiment with changes to all traffic. FIG. 3 further illustrates the steps of this determination process. As shown in FIG. 3, changes with a positive impact are applied to the advertising campaign, while changes with a negative impact are discarded or re-evaluated at a later point.

FIG. 3 is a flow diagram of a process 300 for evaluating campaign changes in accordance with an illustrative embodiment. The process 300 can be implemented on a computing device. In one embodiment, the process 300 is encoded on a computer-readable medium that contains instructions that, when executed by a computing device, cause the computing device to perform operations of the process 300.

Modification data is received from multiple sources 302, 304, and 306. As illustrated, the modification data may include opportunities, recent changes, bulk changes, as well as any other data specifying changes to one or more advertising campaigns. Opportunities 302 can include various suggested changes for one or more advertising campaigns associated with the advertiser, and may be generated manually or automatically by the advertisement management system 110 or another system. For example, new keywords (e.g., “snow shoes”, “skis”) may be suggested to be included in a particular advertising group of an advertising campaign (e.g., “snow equipment”).

The advertisement management system 110 or another system (e.g., an automated opportunity generation system) may, on an intermittent basis, generate one or more changes for at least one of the advertising campaigns associated with an advertiser. In one embodiment, the system determines changes that would potentially positively impact the advertiser's campaigns based on analysis of keywords and various advertising campaign settings used by other advertisers.

Recent changes made by the advertiser 304 include changes previously made by the advertiser. For example, the advertiser might have added new keywords to one of the advertising groups associated with a particular advertising campaign. In some embodiments, the recent changes can be grouped within hour of each other, up to a maximum period.

Bulk changes 306 may include data, imported from another system (e.g., another application used by the advertiser to manage advertisements), indicating one or more suggested changes to the advertiser's campaign. The received modification data may include one or more changes from a previously run experiment. In another embodiment, the advertiser can manually specify one or more changes that they would like to experiment with.

The various changes (e.g., 302, 304, 306) are placed into a queue 308. As shown, the queue 308 includes changes associated with various advertising campaigns (campaigns 1, 3, through N). The queuing of changes and then evaluating them, as illustrated in blocks 310-316, may be two independent asynchronous processes. Accordingly, as some of the changes from the queue are evaluated, advertisers can continue to queue changes to experiment with, and changes are continuously imported into the queue 308 from the various sources.

In one embodiment, only a single experiment can run at any given time. For example, changes for a single advertising campaign (e.g., campaign 1) can be evaluated, while the rest of the changes wait in the queue. In this example, once evaluation of changes for campaign 1 is completed and changes are analyzed and propagated or discarded, changes for another campaign can be evaluated. The order in which changes are evaluated may be determined on a first in first out basis. While an experiment is running, one or more experiments including changes from the queue 308 can be scheduled.

In some embodiments, one or more user interfaces may enable the advertiser to view and manipulate the queue of upcoming experiments. For example, the advertiser may be able to prioritize the queue and select advertising campaigns for which to run experiments first.

The advertisements management system 110 automatically selects one or more changes (e.g., campaign 1 changes) from the queue 308, and evaluates (block 310) them for a predetermined period of time (e.g., a week, a month, etc.). The predetermined period of time may be automatically set to a default value, manually selected by the advertiser, or calculated based on the extent that the changes are evaluated. During the evaluation or experimentation period, the original campaign is tested against the modified version of the campaign (i.e., the original campaign with the one or more changes from the queue) using a portion of user traffic. For example, 50% of user traffic can be applied to the original campaign and the rest to the modified version of the campaign.

Upon completion of the predetermined time period, it is determined whether results are statistically significant (block 312). In some embodiments, the statistical significance is determined by computing the difference between an observed ratio (e.g., difference between number of impressions within experiment split and number of impressions within control split, with respect to the number of impressions within the control split) and an expected ratio (e.g., (1/(1−percentage of auctions that are being randomly diverted towards the experiment split))−2) in units of standard deviation of the metric. Statistical significance may be determined for various metrics including impressions, clicks, conversions, click-through rate, conversion rate, cost per click, average position, etc.

If the results are determined to be statistically insignificant, the changes may be placed back into the queue 308 to be evaluated again at a later point in order to achieve results that are statistically significant. Accordingly, the experiment may be automatically re-run at a later point. For example, an experiment may be retried in a predetermined day interval (e.g., in 15 days). When an experiment is re-run with no change in experiment results, the experiment may be re-run a specific maximum additional number of times (e.g., 3 times).

In another embodiment, the changes that did not achieve statistically significant results can be discarded without being placed back into the queue 308. As shown, optional manual review (block 314) may be performed to further analyze the changes that produced statistically insignificant results.

At block 316, it is determined whether the statistically significant results are aligned with goals. Example goals may include increasing number of impressions, clicks, conversions, etc. Changes or settings that achieved the specified goals or rules are applied to 100% of user traffic (block 320). In other words, the modified campaign would receive 100% of user traffic, while the original campaign would receive none. Conversely, if the results of the experiment were not aligned with the goals, the experimented changes are rejected (block 318) with the original campaign receiving 100% of user traffic.

In some embodiments, when the goals of the experiment are not met, sub-parts of the experiment (e.g., advertising group, keyword, etc.) can be removed from the experiment. The modified experiment may be updated with one or more new changes, and then re-run and evaluated again. In another embodiment, sub-parts of an experiment that passed the goal are selected and re-run as a separate experiment. Re-evaluation of the experiment may be performed on a per change type basis, and the impact determined on keyword, and/or advertising group level.

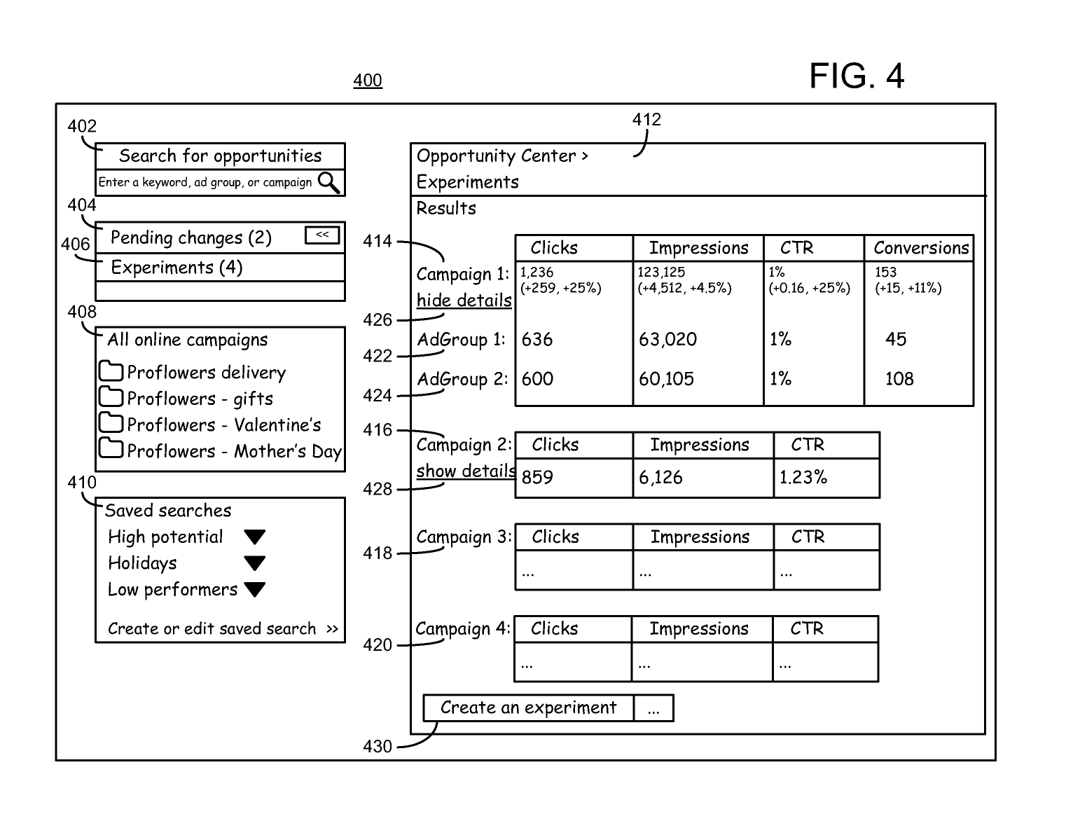

FIG. 4 illustrates a user interface display 400 for creating and managing experiments, as well as for viewing results of one or more experiments, in accordance with an illustrative implementation. As shown, the user interface 400 includes a search for opportunities area 402, which enables advertisers to locate various possible changes to advertising campaigns or advertising groups. For example, the advertiser may search for opportunities or suggested changes for a particular advertising campaign.

The user interface 400 illustrates that there are two pending changes 404 and four experiments 406. In one embodiment, the four experiments 406 include four experiments that have run so far, while the two pending changes are changes that have not been tested yet. In another embodiment, the four experiments 406 include one or more experiments that are currently running. The pending changes 404 and the experiments 406 may include changes that were automatically determined by the advertisement management system 110 and/or manually created by the advertiser.

An area 408 illustrates four campaigns (i.e., “Proflowers deliver”, “Proflowers—gifts”, “Proflowers—valentine's”, and “Proflowers—Mother's day”) that are associated with the advertiser. An area 410 shows three groups of saved searches for opportunities including searches that had high potential, holidays, and low performers. The saved searches enable the user to quickly access various opportunities already suggested to the advertiser during previous searches for opportunities (i.e., using the search for opportunities area 402). The advertiser can create or edit a saved search.

The user interface 400 illustrates an experiments results area 412 displaying top level impact of the experimented changes of the four experiments 406 on four advertising campaigns (i.e., a separate experiment was performed for each campaign). For example, the changes with respect to campaign 1 may be part of an experiment currently running, while changes with respect to the rest of the campaigns have already been evaluated. In this example, the shown results associated with changes to campaign 1 may be updated in real-time or in near real-time.

A notification (e.g., email notification, a message in one of the user interfaces provided by the advertisement management system 110) may be sent to the advertiser a predetermined period of time (e.g., a week, a month) before the experiment ends with a link to the results of the experiment. For example, the notification may include a link to user interfaces 400 or 500. The advertiser can customize notification settings including timing of notification, notification delivery method, etc.

As shown, with respect to campaign 1, a results area 414 displays a detailed view of experimental results. In particular, the results area 414 shows the impact of changes made to campaign 1 on various metrics including clicks, impressions, click-through rate (“CTR”), conversions. For example, as illustrated, modified campaign 1, received 25% more clicks, 4.5% more impressions, and 11% more conversions than the original campaign 1, which resulted in a 25% higher click through rate (CTR). In this example, if 50% of user traffic was allocated to the modified version of campaign 1 and 50% of user traffic was allocated to an original version of campaign 1, then modified campaign 1 received 1,246 clicks whereas the original campaign received 259 clicks less (i.e., 977 clicks). Accordingly, the advertiser can easily visualize and analyze the impact of the changes made to the advertising campaign. The advertiser can intervene during the experiment to promote or cancel part of the experiment based on the viewed experiment results.

The results area 414 illustrates a detailed breakdown of various metrics for every advertising group associated with campaign 1. For example, an advertising group 1 received a total of 646 clicks, while an advertising group 2 received 600 clicks. Although not shown, if changes were made to one or both of the two advertising groups, the results area 414 may show the impact on clicks, impressions, CTR, and conversion for each advertising group. An option 426 allows the advertiser to hide the details including the results breakdown by an advertising group.

Results areas 416, 418, and 420 show experiment results for remaining three campaigns based on experiments that were previously run. Option 428 enables the advertiser to visualize a detailed view of experimental results. For example, by clicking on the option 428, the advertiser may view the impact of changes on campaign 2 including the breakdown of various performance metrics by advertising group, keywords, etc.

Clicking on the experiments 406 or another folder or link in the user interface 400 may provide access to the historic results of previously run experiments (e.g., experiments for campaigns 2, 3, and 4). The historic results of previously run experiments may display specific changes that were evaluated during the experiments as well as their impact (e.g., change in clicks, impressions, CTR, conversions). Although not shown, the user interface 400 or another user interface can enable the advertiser to roll back applied experiments in full or in part, and/or modify and restart stopped experiments.

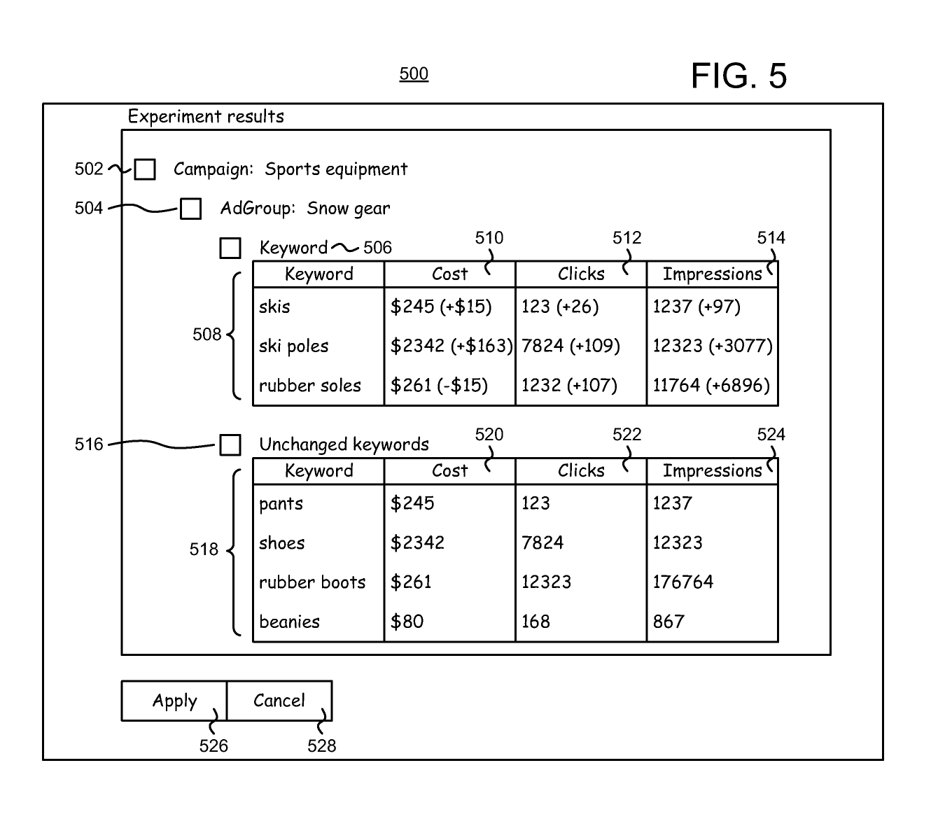

FIG. 5 illustrates a user interface display 500 for further viewing results of an experiment at an advertising group level, in accordance with an illustrative implementation. The user interface 500 illustrates drilldown impact of the changes by displaying data associated with an advertising group “Snow gear” 504 of a campaign “Sports equipment” 502. The user interface 500 displays a set of changed keywords 508, as well as a set of unchanged keywords 518 belonging to the advertising group 504, along with various metrics including cost, clicks, and impressions. The list of unchanged keywords 518 illustrates performance data including cost, clicks and impressions for each of the unchanged keywords.

For each unchanged keyword, the user interface 500 displays the cost, number of clicks, as well as the impact that the change had on the cost, clicks, and impressions. For example, a keyword “skis” received 123 clicks and 1,237 impressions, and had a cost of $245. In this example, the advertiser is shown that with a $15 increase in cost for the “skis” keyword, 26 more clicks and 97 more impressions were generated for the keyword.

With respect to another changed keyword “ski poles”, a $163 cost increase was incurred, and 109 more clicks and 3,077 more impressions were received. The “rubber soles” keyword had a $15 decrease in cost, but experienced an increase in both clicks and impressions. Accordingly, the user interface 500 enables the advertiser to quickly visualize the impact that the various changes to the keywords belonging to the advertising group 504 had on cost, clicks, and impressions. In one embodiment, the advertisement management system 110 automatically determines whether to apply keyword changes to 100% of user traffic. In another embodiment, the advertiser may manually permanently apply one or more changes to the campaign by selecting the desired changes and clicking on the apply button 526. The advertiser may override changes to an advertising campaign that were automatically implemented by the advertisement management system 110 or another system.

Although not illustrated, the user interface 500 may allow the user to choose a date and time range for displaying experiment results. Although only one advertising campaign and one advertising group are illustrated, the user interface 500 can display data for any number of campaigns, advertising groups, keywords, etc.

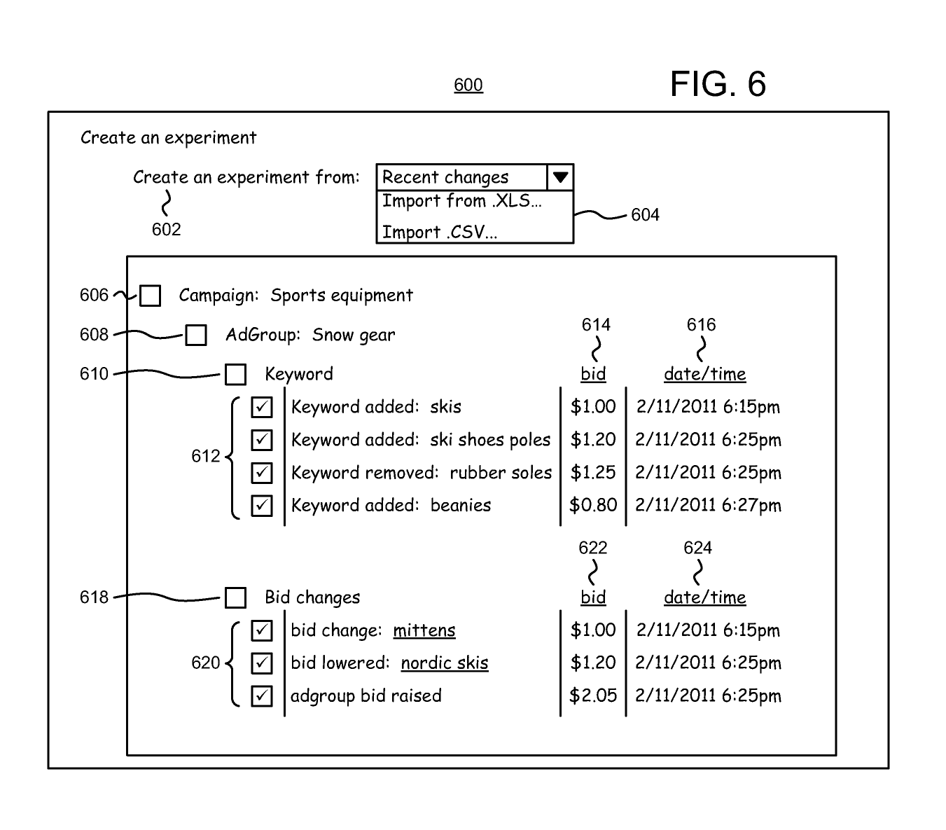

FIG. 6 illustrates a user interface display 600 that enables the advertiser to manually create an experiment, using various changes listed in a recent changes drop down 604, in accordance with an illustrative implementation. The user interface display 600 and other user interfaces provided by the advertisement management system 110 advantageously lower the barrier to create, run and manage experiments.

The drop down 604 lists an option to import changes from an Excel file and/or a .CSV file. The drop down 604 can include any number of sources of campaign changes (e.g., a file generated by the advertisement management system 110 or another system, campaign changes suggested by the advertisement management system, bulk changes, etc.). The advertiser may select one or more of the options listed in the drop down menu 604.

Based on the selection made by the advertiser using the drop down 604, a list of changes 606 is generated and displayed. As shown, a “Sports equipment” campaign includes a “Snow gear” advertising group. A list of keyword changes 612 to the “Snow gear” advertising group includes four items, each item indicating whether a keyword was added or removed, as well as a bid selected for each keyword, and date and time the change was implemented. For example, keyword “skis” was added with a bid of $1, and keyword “rubber soles” was removed. Each item in the list of keyword changes 612 includes a check box. Using these check boxes, the advertiser can individually select which changes to experiment with. For example, the advertiser can choose to only select addition of the “skis” keyword.

The user interface 600 displays a list of bid changes 620 in the “Snow gear” advertising group. Each item in the list 620 includes an indication of a change to a bid, as well as the date and time of that change. For example, bid was lowered for the “nordic skis” keyword to $1.20. Each item in the list 620 includes a check box. Using these check boxes, the advertiser can individually select which bid changes to experiment with. For example, the advertiser can choose to experiment with the first two bid changes.

Various illustrated check boxes (e.g., 606, 608, 610, 618) allow the advertiser to select all the changes listed under an item associated with a selected checkbox. For example, the advertiser may wish to experiment with all the keyword changes by clicking on the checkbox 610. In another example, the advertiser may select all the listed changes for the “Snow gear” advertising group by selecting the checkbox 608.

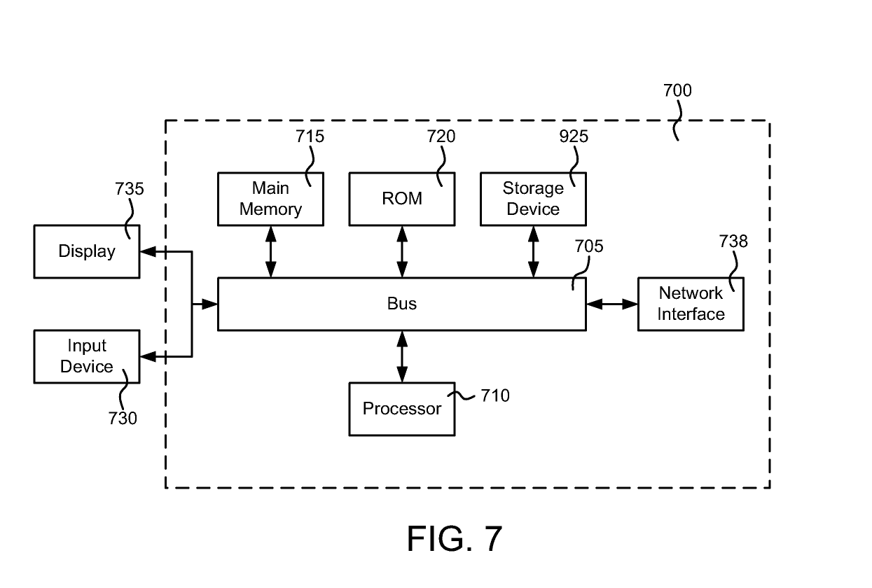

FIG. 7 is a block diagram of a computer system in accordance with an illustrative implementation. The computer system or computing device 700 can be used to implement devices 106 and/or the advertisement management system 110, etc. The computing system 700 includes a bus 705 or other communication component for communicating information and a processor 710 or processing circuit coupled to the bus 705 for processing information. The computing system 700 can also include one or more processors 710 or processing circuits coupled to the bus for processing information. The computing system 700 also includes main memory 715, such as a random access memory (RAM) or other dynamic storage device, coupled to the bus 705 for storing information, and instructions to be executed by the processor 710. Main memory 715 can also be used for storing position information, temporary variables, or other intermediate information during execution of instructions by the processor 710. The computing system 700 may further include a read only memory (ROM) 710 or other static storage device coupled to the bus 705 for storing static information and instructions for the processor 710. A storage device 725, such as a solid state device, magnetic disk or optical disk, is coupled to the bus 705 for persistently storing information and instructions.

The computing system 700 may be coupled via the bus 705 to a display 735, such as a liquid crystal display, or active matrix display, for displaying information to a user. An input device 730, such as a keyboard including alphanumeric and other keys, may be coupled to the bus 705 for communicating information and command selections to the processor 710. In another implementation, the input device 730 has a touch screen display 735. The input device 730 can include a cursor control, such as a mouse, a trackball, or cursor direction keys, for communicating direction information and command selections to the processor 710 and for controlling cursor movement on the display 735.

According to various implementations, the processes described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. In alternative implementations, hard-wired circuitry may be used in place of or in combination with software instructions to effect illustrative implementations. Thus, implementations are not limited to any specific combination of hardware circuitry and software.

Although an example computing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The term “data processing apparatus” or “computing device” or “processing circuit” encompasses all kinds of apparatus, devices, and machines for processing data, including by way of example a programmable processor, a computer, a system on a chip, or multiple ones, a portion of a programmed processor, or combinations of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computerized method of evaluating a change to an advertising campaign of an advertiser, the method comprising:
storing data associated with an advertising campaign in a memory;
receiving, over a network, advertising campaign modification data from one or more campaign modification data sources, wherein the advertising campaign modification data specifies a plurality of changes to the advertising campaign;
receiving, a rule associated with the advertising campaign, the rule evaluating an advertising campaign performance metric against a predefined performance metric value, the advertising campaign performance metric comprising one of click-through rate, clicks, impressions, conversions, amount of time a user spends on a landing page, reduction in cost, conversion rate, cost per click, or average position;
generating, by one or more processors, a queue of changes based on the received advertising campaign modification data, the queue defining an order in which the plurality of changes are to be evaluated;
grouping one or more changes in the queue of changes into a group of changes;
prioritizing the group of changes to evaluate before other changes in the queue of changes;
generating, by one or more processors, a modified version of the advertising campaign incorporating the group of changes from the queue of changes;
evaluating, by one or more processors, the modified version of the advertising campaign for a predetermined period of time using a first percentage of user traffic;
evaluating, by one or more processors, the advertising campaign for the predetermined period of time using a second percentage of user traffic;
computing, by one or more processors, an observed ratio and an expected ratio, the observed ratio computed from performance metric of an evaluation of the modified version and of an evaluation of the advertising campaign, and the expected ratio computed from the first percentage;
comparing, by one or more processors, the observed ratio and the expected ratio; and
determining, by one or more processors, whether to apply the group of changes to the advertising campaign based on the comparison and the rule.

2. The method of claim 1, wherein each of the plurality of changes are: determined by analyzing keywords used by a plurality of additional advertisers;
previously made by an advertiser of the advertising campaign; or
received from a source.

3. The method of claim 1, further comprising applying, by one or more processors, the group of changes to the advertising campaign based on the determination, wherein the comparison is statistically significant.

4. The method of claim 1, further comprising evaluating, by one or more processors, the advertising campaign and the modified advertising campaign for an additional predetermined period of time, wherein the results are statistically insignificant.

5. (canceled)

6. The method of claim 1, wherein determining whether to apply the group of changes includes determining whether the comparison is statistically significant.

7. The method of claim 1, further comprising providing a visual representation of an evaluation of the modified version.

8. The method of claim 1, wherein at least one change of the group of changes is a keyword change.

9. The method of claim 1, wherein at least one change of the group of changes is a change to a keyword bid.

10. The method of claim 1, where the rule is determined based on one or more goals specified by the advertiser.

11. (canceled)

12. A computerized system comprising
one or more processing circuits configured to:
receive, over a network, advertising campaign modification data from one or more campaign modification data sources, wherein the advertising campaign modification data specifies a plurality of changes to an advertising campaign;
receive rule data associated with the advertising campaign, the rule data evaluating an advertising campaign performance metric against a predefined performance metric value, the advertising campaign performance metric comprising one of click-through rate, clicks, impressions, conversions, amount of time a user spends on a landing page, reduction in cost, conversion rate, cost per click, or average position;
generate, by one or more processors, a queue of changes based on the received advertising campaign modification data, the queue defining an order in which the plurality of changes are to be evaluated;
group, by one or more processors, one or more changes in the queue of changes into a group of changes;
prioritize, by one or more processors, the group of changes to evaluate before other changes in the queue of changes;
generate, by one or more processors, a modified version of the advertising campaign incorporating the group of changes from the queue of changes;
evaluate, by one or more processors, the modified version of the advertising campaign for a predetermined period of time using a first percentage of user traffic;
evaluate, by one or more processors, the advertising campaign for the predetermined period of time using a second percentage of user traffic;
compute, by one or more processors, an observed ratio and an expected ratio, the observed ratio computed from performance metric of an evaluation of the modified version and of an evaluation of the advertising campaign, and the expected ratio computed from the first percentage;
compare, by one or more processors, the observed ratio and the expected ratio; and
determine, by one or more processors, whether to apply the group of changes to the first advertising campaign based on results of the evaluating step and the rule data.

13. The system of claim 12, wherein each of the plurality of changes are:
determined by analyzing keywords used by a plurality of additional advertisers;
previously made by an advertiser of the advertising campaign; or
received from a source.

14. The system of claim 12, wherein the one or more processing circuits are further configured to apply, by one or more processors, the group of changes to the advertising campaign based on the determination, wherein the comparison is statistically significant.

15. The system of claim 12, wherein the one or more processing circuits are further configured to evaluate, by one or more processors, the advertising campaign and the modified advertising campaign for an additional predetermined period of time, wherein the results are statistically insignificant.

16. The system of claim 12, wherein the one or more processing circuits are further configured to determine whether results are statistically significant.

17. The system of claim 12, wherein at least one change of the group of changes is a keyword change.

18. The system of claim 12, wherein at least one change of the group of changes is a change to a keyword bid.

19. A non-transitory computer-readable medium having instructions stored thereon, the instructions when executed by one or more processors to perform the instructions to:
receive, over a network, advertising campaign modification data from one or more campaign modification data sources, wherein the advertising campaign modification data specifies a plurality of changes to an advertising campaign;
receive rule data associated with the advertising campaign, the rule data evaluating an advertising campaign performance metric against a predefined performance metric value, the advertising campaign performance metric comprising one of click-through rate, clicks, impressions, conversions, amount of time a user spends on a landing page, reduction in cost, conversion rate, cost per click, or average position;
generate a queue of changes based on the received advertising campaign modification data, the queue defining an order in which the plurality of changes are to be evaluated;
group one or more changes in the queue of changes into a group of changes;
prioritize the group of changes to evaluate before other changes in the queue;
generate a modified version of the advertising campaign incorporating the group of changes from the queue of changes;
evaluate the modified version of the advertising campaign for a predetermined period of time using a first percentage of user traffic;
evaluate the advertising campaign for the predetermined period of time using a second percentage of user traffic;
compute an observed ratio and an expected ratio, the observed ratio computed from performance metric of an evaluation of the modified version and of an evaluation of the advertising campaign, and the expected ratio computed from the first percentage;
compare the observed ratio and the expected ratio; and determine whether to apply the group of changes to the first advertising campaign based on results of the evaluating step and the rule data.

20. The non-transitory computer-readable medium of claim 19, wherein each of the plurality of changes are:
determined by analyzing keywords used by a plurality of additional advertisers;
previously made by an advertiser of the advertising campaign; or
received from a source.
